(19) United States
(12) Patent Application Publication
(10) Pub. No.: US 2026/0369943 A1
(43) Pub. Date: Nov. 19, 2026

(54) CONNECTION ADAPTER FOR CONNECTION TO AN INVERTER OF AN ELECTRIC MACHINE, AND CONNECTION SYSTEM FOR AN INVERTER

(71) Applicant: SEG Automotive Germany GmbH, Stuttgart (DE)

(72) Inventors: Nima SAADAT, Stuttgart (DE); Murugaperumal DEVARAJA, Stuttgart (DE); Gyorgy Gabor JOZSA, Stuttgart (DE); Amadou BAH, Stuttgart (DE); Parag SHAH, Stuttgart (DE)

(21) Appl. No.: 19/679,337

(22) Filed: May 15, 2026

(30) Foreign Application Priority Data
May 16, 2025 (DE) 102025119183.2

(51) Int. Cl. H01R 31/06; H01R 13/64; H01R 13/66

(52) U.S. Cl. CPC H01R 31/065; H01R 13/64; H01R 13/6675

(57) ABSTRACT

A connection adapter for connection to an inverter of an electric machine includes a housing having first and second communication and/or signal terminals, input terminals, output terminals, and pre-charge terminals. A step-down converter arranged within the housing is coupled to the input and output terminals and converts an input voltage present at the input terminals into a lower output voltage at a predetermined output-voltage level at the output terminals. A pre-charge circuit is coupled to the input terminals and the pre-charge terminals and limits an electric current between the input terminals and the pre-charge terminals. Electrical lines connect the first communication and/or signal terminals to the second communication and/or signal terminals. The first communication and/or signal terminals and the input terminals are arranged in a first adapter connection section, and the second communication and/or signal terminals and the output terminals are arranged in a second adapter connection section.

### CROSS-REFERENCE TO RELATED APPLICATIONS / PRIORITY CLAIM

This application claims priority to German Patent Application No. DE 10 2025 119 183.2, filed May. 16, 2025, the entire contents of which are incorporated herein by reference.

### FIELD

The present disclosure relates to a connection adapter for connection to an inverter of an electric machine and to a connection system for an inverter.

### BACKGROUND

In vehicles, such as automobiles or trucks, electric machines may be used to drive the vehicle or, in the case of a hybrid vehicle, to drive the vehicle partially and/or intermittently. Electric machines may be operated as motors (e.g., during acceleration) and as generators (e.g., during braking or for power generation). Voltage is applied to windings of electric machines, for example using an inverter (power converter circuit) that is controlled by an inverter control unit. The inverter control unit receives, for example, information representing a setpoint specified by a higher-level control unit of the vehicle, for example an engine control unit, such as a target speed or a target torque, and controls the inverter and therefore the electric machine accordingly.

The inverter control unit and other electrical components in the vehicle are designed for a particular supply-voltage level. For a long time, 12 V batteries were used for voltage supply and components were designed accordingly. More recently, 24 V or 48 V batteries are increasingly being used.

Development and certification of components for vehicles involves substantial effort. Accordingly, it is desirable to enable use of existing inverters and other electrical components for vehicle electrical systems having different supply-voltage levels.

### SUMMARY

A connection adapter for connection to an inverter of an electric machine and a connection system for an inverter are provided as set forth in the independent claims, and advantageous implementations are set forth in the dependent claims and the description below.

A connection adapter for connection to an inverter of an electric machine includes at least one housing, wherein walls of the at least one housing include first and second communication and/or signal terminals, input terminals, output terminals, and pre-charge terminals.

A step-down converter is arranged within the at least one housing and is coupled to the input terminals and the output terminals, and is configured to convert an input voltage present at the input terminals into a lower output voltage at a predetermined output-voltage level at the output terminals.

A pre-charge circuit is arranged within the at least one housing and is coupled to the input terminals and the pre-charge terminals, and is configured to limit an electric current between the input terminals and the pre-charge terminals.

The first and second communication and/or signal terminals are electrically connected to one another by electrical lines running within the at least one housing. The first communication and/or signal terminals and the input terminals are arranged in a first adapter connection section at a wall of the at least one housing. The second communication and/or signal terminals and the output terminals are arranged in a second adapter connection section at a wall of the at least one housing.

The connection adapter enables use of inverters and electrical components that include a capacitor with DC voltage sources that provide a higher voltage than that for which the respective inverter and the respective electrical component are designed. All signals required for control and voltage supply of the inverter can be provided via the connection adapter.

Unless indicated otherwise, the terms “connected,” “connectable,” or similar terms are used to mean electrically conductive connections. Unless indicated otherwise, the term “terminal” refers to an electrical terminal, for example a conductive contact. The input terminals and the output terminals provide voltage supply and may also be referred to as input voltage-supply terminals and output voltage-supply terminals.

The input terminals are configured for connection to at least one DC voltage source. The first communication and/or signal terminals are configured for connection to a control unit. The pre-charge terminals are configured for connection to a capacitor of an electrical component. The second communication and/or signal terminals and the output terminals are configured for connection to corresponding terminals of an inverter.

The expression “at least one housing” is used to mean that either a single housing is provided, two housings (a first housing and a second housing), or more than two housings are provided.

In some implementations, the at least one housing is a single housing, wherein the pre-charge terminals may be arranged in the first adapter connection section. This enables a compact configuration and/or enables simple connection (including all terminals and lines) of a cable harness to the connection adapter via a single plug connection.

In some implementations, the at least one housing includes a first housing and a second housing, wherein the step-down converter is arranged within the first housing and the first and second adapter connection sections are arranged at a wall of the first housing; the pre-charge circuit is arranged within the second housing and the pre-charge terminals are arranged in a pre-charge connection section at a wall of the second housing; a housing connecting component is provided between the first housing and the second housing and includes electrical lines that connect the pre-charge circuit to the input terminals. The electrical lines that connect the first communication and/or signal terminals to the second communication and/or signal terminals run within the first housing. This two-part configuration with two housings may be useful where installation space is limited, because the two housings can be relatively small and can be positioned independently in small free spaces. The housing connecting component is in particular a housing connecting cable, but can also be implemented as a non-flexible molded part. The housing connecting component can be connectable to, or connected to, the first housing and the second housing by electrical plug connections. Alternatively, pass-through openings can be provided in the first and second housings through which the housing connecting component (e.g. housing connecting cable) is routed, and ends of lines routed in the housing connecting component can be connected individually to a respective circuit board, for example by solder connections or plug contacts.

In some implementations, the first adapter connection section includes a keying structure in the form of projections and/or recesses at the wall of the at least one housing at which the first adapter connection section is arranged. Alternatively or additionally, the second adapter connection section includes a keying structure in the form of projections and/or recesses at the wall of the at least one housing at which the second adapter connection section is arranged. The keying structures may be considered guide elements that ensure that, when connecting to a cable harness and/or the inverter, electrical contact is established between associated terminals.

In some implementations, the keying structure of the first adapter connection section is integrally formed with the wall at which the first adapter connection section is arranged. Alternatively or additionally, the keying structure of the second adapter connection section is integrally formed with the wall at which the second adapter connection section is arranged. An integral, i.e., one-piece, implementation enables simple manufacture, for example by injection molding.

In some implementations, the keying structure of the first adapter connection section is configured as a socket or plug for a plug connection. Alternatively or additionally, the keying structure of the second adapter connection section is configured as a socket or plug for a plug connection. This enables connections to a cable harness and/or the inverter to be established by plugging together. The keying structures may include retaining elements and/or fastening elements to secure the connection after plugging together.

In some implementations, the keying structure of the second adapter connection section is complementary to a keying structure of an inverter connection section on a housing of an inverter to which the connection adapter is to be connected. This enables, for example, simple mounting to the inverter by a plug connection.

In some implementations, the second adapter connection section is connectable to an inverter connection section of the inverter such that the second communication and/or signal terminals and output terminals arranged in the second adapter connection section contact corresponding communication and/or signal terminals and voltage-supply terminals in the inverter connection section when the second adapter connection section is connected to the inverter connection section. Accordingly, the connection adapter can be attached directly to the inverter (without a cable or the like) and connected to the corresponding terminals.

In some implementations, the input terminals include first input terminals that are coupled to the step-down converter and to the pre-charge circuit. This supports use with a single DC voltage source.

In some implementations, the input terminals include first input terminals and second input terminals, wherein the first input terminals are coupled to the step-down converter and the second input terminals are coupled to the pre-charge circuit. This supports use of two DC voltage sources, for example having different nominal voltages, where a first DC voltage source is connected or connectable to the first input terminals and a second DC voltage source is connected or connectable to the second input terminals. In particular, the first DC voltage source may be permanently connected to the first input terminals, so that the input voltage supplied by the first DC voltage source is always present at the first input terminals and, consequently, the output voltage is always present at the output terminals; the connection between the second DC voltage source and the second input terminals may be switchable on and off, or connectable and disconnectable. This is advantageous if the inverter is to be permanently supplied with voltage, i.e. if the inverter’s power supply terminals connected to the output terminals are so-called KL30 and KL31 terminals (KL30, 31: terminals 30, 31), or if a capacitor of an electrical component connected to the pre-charge terminals is to be pre-charged only at certain times.

In some implementations, the pre-charge circuit includes a step-up converter. Using the step-up converter, after switching on a DC voltage source at the input terminals, the voltage at the pre-charge terminals can be increased from zero over a period of time and can in particular reach a higher voltage level than that of the DC voltage source.

In some implementations, the predetermined output-voltage level is in a range from 5 V to 18 V and in particular has a nominal voltage of 12 V. Alternatively or additionally, the step-down converter is configured such that the input voltage can be in a range from 20 V to 100 V, in particular from 20 V to 50 V. For example, batteries with a nominal voltage of 24 V or 48 V can be used and connected to the input terminals.

In some implementations, the second adapter connection section is arranged at a wall of the at least one housing opposite a wall of the at least one housing at which the first adapter connection section is arranged. Alternatively, the first and second adapter connection sections are arranged at a wall on the same side of the at least one housing. Alternatively, the second adapter connection section is arranged at a wall that forms an angle in a range from 60° to 120° with the wall at which the first adapter connection section is arranged, wherein the angle is in particular 90°. These implementations support, for example, adaptation to different installation-space conditions.

A connection system for an inverter includes a connection adapter as described above and a cable harness having electrical lines, wherein a cable connection section is arranged at a first end of the cable harness and includes terminals coupled to the electrical lines and is connectable to, or connected to, the first adapter connection section such that electrical contact is established between terminals in the cable connection section and the first communication and/or signal terminals, the input terminals, and the pre-charge terminals. This supports simple installation of the connection adapter.

In some implementations, the electrical lines of the cable harness include communication lines, voltage supply lines, and pre-charge lines that are initially routed together in the cable harness starting from the first end, and at a second end are routed separately in a communication cable, a voltage supply cable, and a pre-charge cable so that the communication cable is connectable to a control unit, the voltage supply cable is connectable to a DC voltage source, and the pre-charge cable is connectable to an electrical component that includes a capacitor. Routing the lines together initially enables simple and space-saving installation.

In some implementations, the connection system further includes an intermediate cable having a first intermediate-cable connection section and a second intermediate-cable connection section at ends of the intermediate cable, wherein terminals in the first intermediate-cable connection section are electrically connected by electrical lines to terminals in the second intermediate-cable connection section.

The first intermediate-cable connection section is connectable to the second adapter connection section, and the terminals provided in the first intermediate-cable connection section come into contact with or are in contact with corresponding second communication and/or signal terminals and output terminals, when the first intermediate-cable connection section is connected to the second adapter connection section.

The second intermediate cable connection section is connectable to an inverter connection section of the inverter, so that the connections provided in the second intermediate cable connection section come into contact with or are in contact with corresponding communication and/or signal terminals and power supply terminals in the inverter connection section, when the second intermediate cable connection section is connected to the inverter connection section. The intermediate cable allows the connection adapter to be positioned freely, regardless of the position of the inverter connection section on the inverter. This may be advantageous, for example, for reasons of space.

Further advantages and embodiments of the invention are apparent from the description and the accompanying drawing.

The invention is schematically illustrated in the drawing by means of embodiments and is described below with reference to the drawing.

### BRIEF DESCRIPTION OF THE DRAWINGS

FIG. 1 illustrates an example configuration of an electric drive system that includes a connection adapter according to an example implementation.

FIG. 2 illustrates an example configuration of an electric drive system that includes a connection adapter according to another example implementation.

FIG. 3 schematically illustrates a connection system including a connection adapter according to an example implementation, for use in an electric drive system.

FIGS. 4A and 4B illustrate circuit diagrams of example step-down converters.

FIGS. 5A and 5B illustrate circuit diagrams of example pre-charge circuits.

FIG. 6 illustrates perspective views of an inverter and a connection adapter.

FIG. 7 illustrates perspective views of an inverter connected to an electric machine, and another connection adapter.

FIG. 8 illustrates perspective views of an inverter connected to an electric machine, and a further connection adapter.

### DETAILED DESCRIPTION

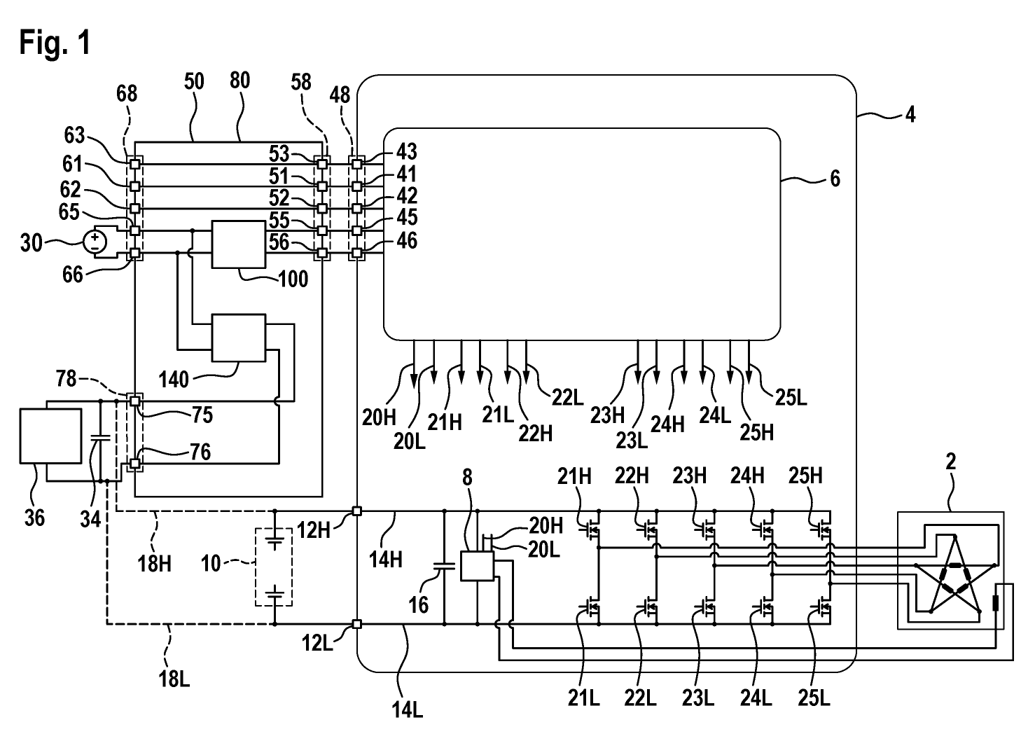

FIG. 1 illustrates an example configuration of an electric drive system that includes a connection adapter according to an example implementation. The electric drive system may be provided in a vehicle, in particular a hybrid vehicle in which the electric drive system supports an internal-combustion engine depending on operating conditions (a so-called mild hybrid configuration). The relative sizes of the components are not shown to scale in FIG. 1 and in the other figures.

The drive system includes an electric machine 2, e.g. a five-phase separately excited synchronous machine, and an inverter 4 that supplies phase windings of the electric machine 2 with electric currents. The inverter 4 includes five half-bridges, each having two semiconductor switching elements (e.g. MOSFET or IGBT) whose gate/control terminals are driven by control signals 21H/21L through 25H/25L. The phase windings of the electric machine 2 are connected to terminals or taps between the two semiconductor switching elements of each half-bridge. The number of phases (five) and corresponding number of half-bridges are examples; in general, the electric machine can have a different number of phases and can also be a different type of machine, e.g. a permanent magnet synchronous machine.

An excitation winding of the electric machine 2 is supplied with electric current by an excitation circuit 8 that is driven by control signals 20H and 20L.

The half-bridges and the excitation circuit are connected between DC link lines 14H and 14L, which are connected to DC terminals 12H and 12L arranged at a housing of the inverter 4. A capacitor 16 may be connected between the DC link lines 14H and 14L to smooth a DC voltage between the DC link lines. The DC terminals 12H and 12L are also commonly referred to as terminal 40 (KL40) and terminal 41 (KL41), where DC terminal 12H is terminal KL40 to which a higher voltage level is supplied, and DC terminal 12L is terminal KL41 to which a lower voltage level, in particular a ground potential, is supplied. The electric machine can have a configuration different from that shown, for example having a different number of phases and/or being a permanent-magnet synchronous machine, and the inverter can be configured accordingly.

The DC terminals 12H and 12L are connectable to a traction battery 10 that provides a DC voltage. The traction battery 10 delivers electrical power to the electric machine via the inverter when the electric machine 2 operates as a motor, and receives electrical power from the electric machine via the inverter when the electric machine 2 operates as a generator. The DC voltage of the traction battery 10 may be greater than 30 V and typically greater than 40 V, for example in a range from 40 V to 100 V, in particular 48 V, e.g. in so-called mild-hybrid applications, in which the electric drive system is used in certain situations in addition to an internal combustion engine and/or instead of the internal combustion engine. More generally, the DC voltage of the drive battery 10 may also be higher, i.e. exceed 100 V and reach over 1,000 V, in particular 400 V or 800 V, e.g. in fully electric vehicles.

The inverter 4 includes an inverter control unit 6 configured to generate the control signals 20H/20L through 25H/25L. The inverter control unit 6 can be implemented by a microcontroller or one or more processors, and generates the control signals, for example, so that a target torque or a target speed specified by a higher-level control unit is achieved. Communication and/or signal terminals 41 and 42 may be provided at the inverter 4 for bus lines (e.g., CAN_H and CAN_L of a CAN bus) coupled to the inverter control unit 6 and via which the inverter control unit 6 can, in particular, receive control instructions and/or send messages (e.g. status messages), for example from or to the higher-level control unit.

A further terminal 43 may be provided for receiving a vehicle on/off signal (terminal 15 or KL15). This terminal can be considered a signal terminal. For voltage/current supply, voltage supply terminals 45 and 46 for a DC voltage may be provided. The terminals 41, 42, and 43 may be collectively referred to as communication and/or signal terminals in this application, and corresponding terminals on the connection adapter may be referred to as first and second communication and/or signal terminals. Similarly, the corresponding terminals on the connection adapter are also referred to as the first and second communication and/or signal terminals; see below. Naturally, other communication and/or signal terminals than those shown may generally be provided.

The communication and/or signal terminals 41, 42, and 43 and the voltage supply terminals 45 and 46 are arranged in an inverter connection section 48 at the housing of the inverter 4. The inverter connection section 48 may include a keying structure (e.g., projections and/or elevations) that enables connection to a complementary keying structure such that, after connection, the two keying structures are fixed relative to one another in at least two orthogonal directions which can be parallel to housing walls of the inverter. For example, the inverter connection section 48 can be configured with a keying structure in the form of a socket or plug for a plug connection. The keying structure can in particular be formed integrally with the housing wall of the inverter. In FIG. 1, the inverter connection section 48 is shown by way of example directly in a wall of the housing of the inverter, and it is also possible for the housing to include a protrusion in which the inverter connection section 48 is formed.

The DC voltage required by the inverter control unit 6 typically has a voltage level of at least 5 V and less than 18 V or less than 16 V, in particular 12 V. This may be due, for example, to electronic components used in the inverter control unit 6.

In vehicles (passenger cars and lorries, as well as construction machinery), batteries with a voltage of 24 V (particularly in passenger cars) or 48 V (particularly in lorries and construction machinery) are increasingly being used instead of 12 V batteries. Such batteries therefore have a voltage level that is not suitable for the inverter control unit 6. Furthermore, the higher voltage level (compared to 12 V batteries) leads to higher inrush charging currents in capacitors (smoothing capacitors and/or buffer capacitors) used in other components of the vehicle, which in turn can lead to electromagnetic interference and/or damage.

This issue can be advantageously addressed using a connection adapter 50. The connection adapter 50 includes a housing 80 with walls, wherein on one or more walls, on an input side, first communication and/or signal terminals 61, 62, and 63, first input terminals 65 and 66, and pre-charge terminals 75 and 76 are provided, and wherein on an output side second communication and/or signal terminals 51, 52, and 53 and output terminals 55 and 56 are provided. The connection adapter 50 further includes a step-down converter 100 and a pre-charge circuit 140 arranged within the housing 80.

The first communication and/or signal terminals 61, 62, and 63 and the first input terminals 65 and 66 may be arranged in a first adapter connection section 68 at the housing of the connection adapter 50. The pre-charge terminals 75 and 76 may be arranged in a pre-charge connection section 78 at the housing 80 of the connection adapter 50, and may alternatively be arranged in the first adapter connection section so that the pre-charge connection section 78 is combined with the first adapter connection section 68. The second communication and/or signal terminals 51, 52, and 53 and the output terminals 55 and 56 may be arranged in a second adapter connection section 58 at the housing 80 of the connection adapter 50.

In the illustrated implementation, the second adapter connection section 58 is connectable to the inverter connection section 48 such that, when the connection is established, the second communication and/or signal terminals 51, 52, and 53 contact the communication and/or signal terminals 41, 42, and 43 of the inverter and the output terminals 55 and 56 contact the voltage supply terminals 45 and 46 of the inverter.

The connection sections of the connection adapter, i.e., the first adapter connection section 68, the second adapter connection section 58, and optionally the pre-charge connection section 78, may include a keying structure, for example in the form of projections and/or elevations, that enables connection to a complementary keying structure such that, after connection, the two keying structures are fixed relative to one another in at least two orthogonal directions. The connection sections can be configured, for example, as a socket or plug for a plug connection. The keying structure of the connection sections of the connection adapter can be formed integrally with a wall of the housing 80 of the connection adapter 50. The keying structure of the second adapter connection section 58 can be complementary to the keying structure of the inverter connection section 48 of an inverter for which the connection adapter is provided. Walls of the housing of the connection adapter 50 can be shaped such that the housing has one or more protrusions or wall elements protruding from an essentially cuboid base shape. The terminals of the connection adapter can be arranged in such protrusions or wall elements, so that the protrusions or wall elements can be considered part of the keying structure.

In FIG. 1, the first adapter connection section 68 and the second adapter connection section 58 are arranged by way of example on opposite walls of the housing 80 of the connection adapter. Alternatively, both adapter connection sections can be arranged at a wall on the same side of the housing, or on two walls that form an angle with one another, for example in a range from 60° to 120° and in particular 90°. The different implementations enable different placements of the connection adapter at the inverter and different routing of a cable harness connected to the first adapter connection section and may in particular support adaptation to installation-space conditions (e.g. in the engine compartment of a vehicle).

The first communication and/or signal terminals 61, 62, and 63 are connected pairwise to the second communication and/or signal terminals 51, 52, and 53 by electrical lines running within the housing 80. Signals between the first and second communication and/or signal terminals are not modified, aside from resistance of the electrical lines that can be regarded as negligible.

The first input terminals 65 and 66 are configured for connection to a DC voltage source and are coupled to the output terminals 55 and 56 via the step-down converter 100 arranged within the housing 80, e.g. input terminal 65 with a positive or higher potential, and input terminal 66 with a negative or lower potential or ground). The step-down converter 100 is configured to convert a DC voltage present between the first input terminals 65 and 66 into a lower output voltage present between the output terminals 55 and 56. The step-down converter 100, or a control unit of the step-down converter, can be configured such that the output voltage level is equal to a setpoint or predetermined output-voltage level, assuming that the DC voltage present between the first input terminals 65 and 66 (provided in FIG. 1 by a first DC voltage source 30) has a level higher than the predetermined output-voltage level. In this way, an inverter, or an inverter control unit, that expects the predetermined output-voltage level as a supply voltage can be supplied by a voltage source that provides a higher voltage.

The step-down converter 100 can be configured such that an input voltage present at the input terminals 65 and 66 can be in a range from 20 V to 100 V. The predetermined output-voltage level is determined by requirements of the inverter control unit and is in particular in a range from 5 V to 18 V, for example 12 V.

The connection adapter 50 further includes a pre-charge circuit 140 arranged within the housing 80. The pre-charge circuit 140 is coupled to the first input terminals 65 and 66 and to the pre-charge terminals 75 and 76. Assuming that the first DC voltage source 30 is connected to the first input terminals 65 and 66 and that an electrical component including a capacitor 34 is connected to the pre-charge terminals 75 and 76, the pre-charge circuit 140 is configured to limit an electric current between the first input terminals 65 and 66 and the pre-charge terminals 75 and 76. In other words, current flow from the input terminal 65 through the pre-charge circuit 140 to the pre-charge terminal 75, and from there through the electrical component to the pre-charge terminal 76, and back through the pre-charge circuit 140 to the input terminal 66 is limited, assuming that a positive or higher potential is supplied to input terminal 65 and a negative or lower potential is supplied to input terminal 66. The limitation can depend on the voltage present between the first input terminals.

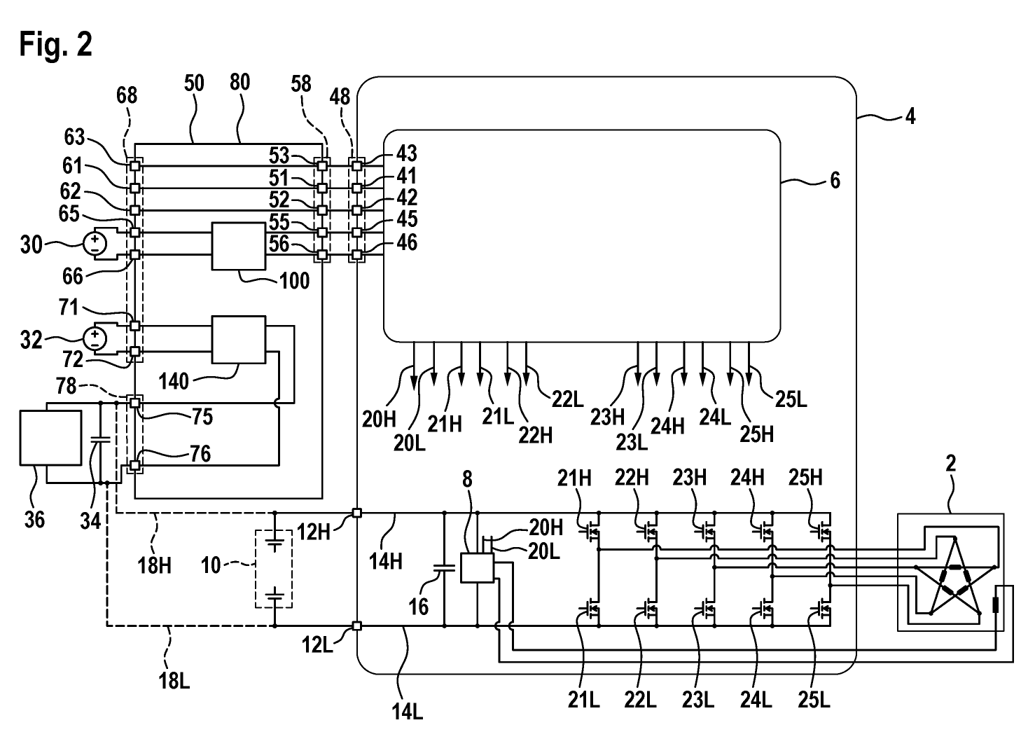

The electrical component can include, besides the capacitor 34, a load 36, wherein the capacitor 34 can serve, for example, as a smoothing capacitance and/or buffer capacitance for a DC supply voltage with which the load 36 is supplied. This DC supply voltage for the load 36 can be provided in a switchable manner by a voltage source (e.g., the DC voltage source 30 or another voltage source) via supply lines, and can be equal to or greater than the voltage provided by the DC voltage source 30. By switching on the DC supply voltage for the load 36 with a time delay after providing the DC voltage from the DC voltage source 30 at the first input terminals 65, 66 (or in FIG. 2 from the DC voltage source 32 at the second input terminals 71, 72), the capacitor 34 can be pre-charged via the pre-charge circuit 140, and high inrush currents can be avoided due to the current limitation by the pre-charge circuit and the delayed switching on of the supply voltage for the load. The time delay is set, for example, so that capacitor 34 has already reached a charge level at which the remaining charging current is sufficiently low.

It can also be provided that the capacitor 34 is connected to the DC terminals 12H and 12L of the inverter 4, for example via connection lines 18H and 18L. In such a case, one terminal of the capacitor 34 connected to the pre-charge terminal 75 can be connected to the DC terminal 12H via the connection line 18H, and the other terminal of the capacitor 34 connected to the pre-charge terminal 76 can be connected to the DC terminal 12L via the connection line 18L. In principle, the load 36 can be omitted, or the half-bridge arrangement and/or the electric machine can form the load connected to the capacitor 34. The capacitor 34 can be an external capacitor, and it is also possible for the capacitor to be arranged internally in the inverter so that capacitor 34 corresponds to capacitor 16, and capacitor 16 is the capacitor to be charged by the pre-charge circuit.

Furthermore, such configurations (i.e. with connecting lines 18H, 18L) can be used in a drive system in which no traction battery 10 is provided, wherein, for example, an internal combustion engine is provided alongside the electric machine (a so-called mild hybrid). In this case, the capacitor 34 (or capacitor 16) serves as a buffer storage for electrical energy regenerated by the electric machine 2. The capacitor 34 can then be initially charged to a certain voltage level, e.g. approximately 24 V, to enable operation of the half-bridge arrangement, and subsequently (if necessary after disconnecting the capacitor from the pre-charge circuit, as described below) serve as a buffer storage for recovered electrical energy, which is then generated, for example, by the inverter at a voltage level of, for example, approximately 48 V. Electrical energy can be regenerated, for example, during braking operations of the vehicle in which the drive system is used. To prevent the voltage level of the capacitor 34 from falling too low during a period in which no braking operations occur, provision may be made to maintain the capacitor 34 at a sufficient voltage level via the coupling with the internal combustion engine, so that the pre-charge circuit is used, for example, only when the vehicle is started.

Switching elements (not shown) can be provided to disconnect and reconnect the electrically conductive connection between the capacitor 34 and the pre-charge circuit 140. Such switching elements can be provided externally (outside the connection adapter) between the pre-charge terminals 75 and 76 and the capacitor 34, or internally in the connection adapter between the pre-charge circuit 140 and the pre-charge terminals. The switching elements can be controlled so that they switch from a closed state to an open state when the capacitor is sufficiently charged, for example based on voltage across the capacitor or based on time. In the case of an internal design, for example, a control system may be provided which switches the switching elements from the closed to the open state in response to the voltage or time trigger.

The step-down converter 100 and the pre-charge circuit 140 can be arranged together on a circuit board. Alternatively, the step-down converter 100 can be arranged on a first circuit board and the pre-charge circuit 140 can be arranged on a second circuit board different from the first circuit board. In this latter implementation, the two circuit boards can be arranged one above the other in the housing in a direction orthogonal to the plane of the circuit boards, enabling a compact connection adapter.

Fastening elements can be provided on the housing 80 of the connection adapter 50 for fastening to the housing of the inverter, for example protrusions with holes for screws and/or threads, and complementary fastening elements can be provided on the inverter housing.

FIG. 2 illustrates an example configuration of an electric drive system including a connection adapter according to another example implementation. The connection adapter of FIG. 2 corresponds in large part to that of FIG. 1, and the description below primarily addresses differences.

In contrast to FIG. 1, the connection adapter of FIG. 2 includes second input terminals 71 and 72 in addition to the first input terminals 65 and 66, and the pre-charge circuit 140 is coupled not to the first input terminals 65 and 66 but rather to the second input terminals 71 and 72. The step-down converter 100 remains coupled to the first input terminals 65 and 66 as in FIG. 1. The second input terminals 71 and 72 are in particular also arranged in the first adapter connection section 68. Accordingly, the pre-charge circuit 140 can be supplied by a second DC voltage source 32 different from the first DC voltage source 30, which can be connected to the second input terminals 71 and 72.

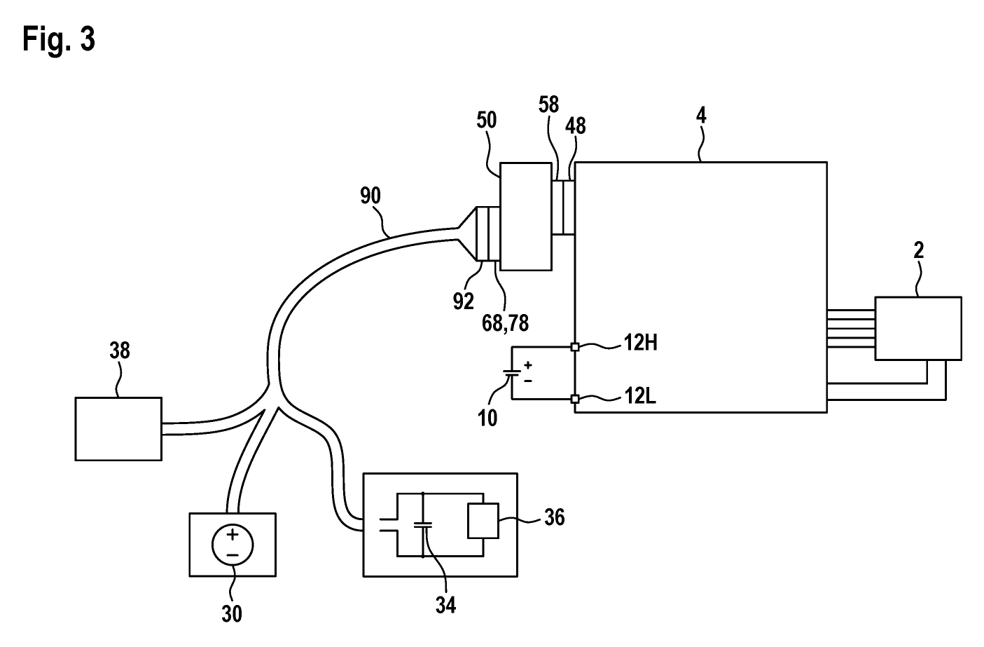

In FIGS. 1 and 2 (as also in FIGS. 3 and 6–8), a single housing is shown that accommodates both the step-down converter 100 and the pre-charge circuit 140. Alternatively, it is possible to provide two housings, wherein the step-down converter 100 is accommodated in a first housing and the pre-charge circuit 140 is accommodated in a second housing different from the first housing. In this case, the first and second adapter connection sections are arranged on the first housing that accommodates the step-down converter 100, and the electrical lines that connect the first communication and/or signal terminals 61, 62, 63 to the second communication and/or signal terminals 51, 52, 53 are routed through this first housing. The pre-charge terminals 75 and 76 are then arranged in a pre-charge connection section on the second housing that accommodates the pre-charge circuit 140. The first and second housings can be connected, for example, via a housing connecting cable (or more generally a housing connecting component) in which electrical lines are routed that connect the pre-charge circuit to the respective input terminals i.e. if, as shown in FIG. 1, only the first input terminals 65, 66 are provided, then with the first input terminals 65, 66; or, if, as shown in FIG. 2, first input terminals 65, 66 and second input terminals 71, 72 are provided, then with the second input terminals 71, 72. The first input terminals and, if present, the second input terminals are in any case arranged on the first housing, namely in the first adapter connection section 68.

FIG. 3 schematically illustrates a connection system including a connection adapter 50 according to an example implementation, for use in an electric drive system, wherein reference numerals already introduced in FIGS. 1 and 2 are used and reference is made to the description of FIGS. 1 and 2.

As in FIG. 1, the electric drive system includes an electric machine 2, an inverter 4, and a traction battery 10, wherein phase windings of the electric machine 2 are connected to the traction battery 10 via the inverter 4, and an inverter connection section 48 is provided at the housing of the inverter 4.

As previously explained, the connection adapter 50 comprises a first adapter connection section 68 combined with the pre-charge connection section 78 and a second adapter connection section 58. The pre-charge terminals 75, 76 are arranged, for example, in the combined first/pre-charge adapter connection section 68, 78. Furthermore, the connection system comprises, in addition to the connection adapter 50, a cable harness 90, on one end of which a cable connection section 92 is provided. In particular, the cable connection section 92 is structurally configured, as described for the other connection sections, e.g. in the form of a plug, wherein the structure of the cable connection section 92 is complementary to that of the combined first/pre-charge adapter connection section 68, 78, so that a coupling, e.g. a plug connection, of the cable connection section 92 with the combined first/pre-charge adapter connection section 68, 78 can be established (shown state).

In the cable harness 90, electrical lines are routed together, for example communication lines, voltage supply lines, and pre-charge lines. In the cable connection section 92, terminals coupled to the electrical lines are provided that correspond to the first communication and/or signal terminals, the first input terminals and optionally the second input terminals, and the pre-charge terminals, so that corresponding terminals are electrically connected when the cable connection section 92 is coupled to the first adapter connection section. For example, the communication lines are connected to terminals in the cable connection section that correspond to the first communication and/or signal terminals; the power supply lines are connected to terminals in the cable connection section that correspond to the first and, where applicable, the second input terminals, and the pre-charge lines are connected to terminals in the cable connection section that correspond to the pre-charge terminals. At the other end of the cable harness 90, the lines are no longer routed together, but rather are divided, for example into a communication cable connected to a higher-level control unit 38, a voltage supply cable connected to a voltage source 30, and a pre-charge cable connected to a capacitor 34 of an electrical component.

Routing the lines together in the cable harness and the ability to connect via the cable connection section enables a simple and space-saving connection of the inverter to the voltage source 30, the control unit 38, and the capacitor 34 of the electrical component.

An intermediate cable (not shown) can be provided that connects the second adapter connection section 58 to the inverter connection section 48, wherein a first connection section of the intermediate cable is connected to, or can be connected to, the adapter connection section, and a second connection section of the intermediate cable can be connected to the inverter connection section.

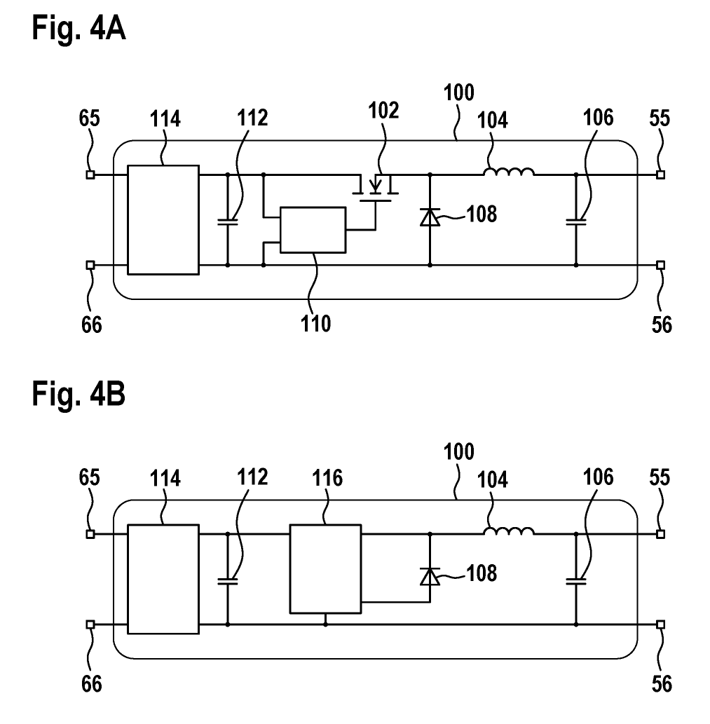

FIGS. 4A and 4B illustrate circuit diagrams of example step-down converters 100, each coupled on the input side to the input terminal 65 (e.g., higher potential) and the input terminal 66 (e.g., lower potential) and on the output side to the output terminals 55 and 56.

In FIG. 4A, a semiconductor switching element 102 (e.g. MOSFET), an inductor 104, and a capacitor 106 are connected in series between the input terminal 65 and the output terminal 56, and a terminal of the capacitor 106 is connected to the output terminal 55 and the other terminal of the capacitor 106 is connected to the output terminal 56 and the input terminal 66. A freewheeling diode 108 is provided so that, when the semiconductor switching element 102 is switched off, current can continuously flow through the inductor 104. By switching the semiconductor switching element 102 on and off at a suitable frequency, a step-down converter is realized, and an input voltage between the input terminals 65 and 66 is converted into a lower output voltage between the output terminals 55 and 56. Switching is controlled by a control unit 110 coupled to a control terminal of the semiconductor switching element 102. Optionally, an input capacitor 112 can be provided to smooth the input-side voltage and/or a circuit 114 can be provided to suppress electromagnetic interference at the input terminals, for example including a suppressor diode or Zener diode to limit voltage spikes.

FIG. 4B corresponds substantially to FIG. 4A, except that the semiconductor switching element 102 and the control unit 110 are integrated in an integrated control unit 116.

The topologies shown are examples, and other topologies may be used, for example isolated or non-isolated, synchronous or asynchronous, and/or a SEPIC.

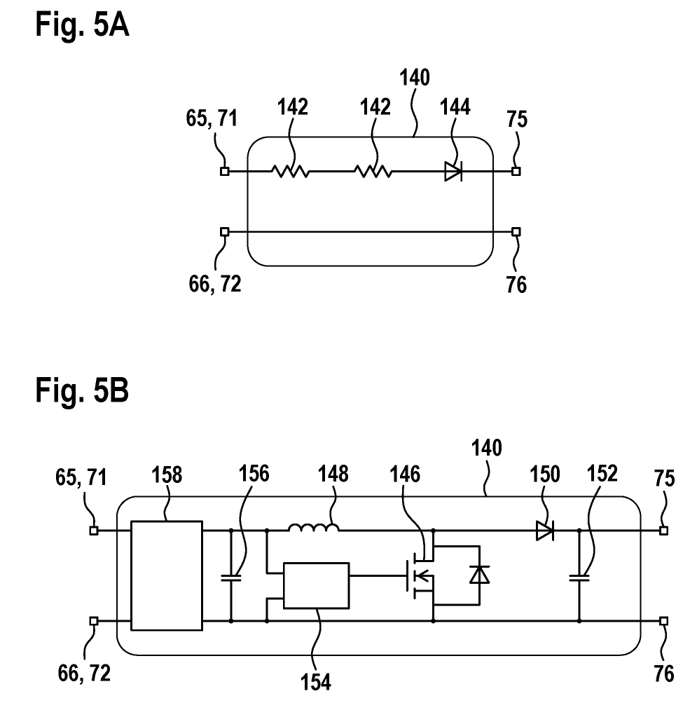

FIGS. 5A and 5B illustrate circuit diagrams of example pre-charge circuits 140.

In FIG. 5A, the pre-charge circuit 140 is implemented as a passive circuit using resistance elements to limit current. For example, resistance elements 142 and a diode 144 are connected in series between the input terminal 65 (or input terminal 71 in FIG. 2) and the pre-charge terminal 75, and the input terminal 66 (or input terminal 72 in FIG. 2) and the pre-charge terminal 76 are connected directly by an electrical line.

In FIG. 5B, the pre-charge circuit 140 is implemented as an active circuit and in principle forms a step-up converter. An inductor 148 is on the one end coupled to the input terminal 65 (or input terminal 71 in FIG. 2) and on the other end via a diode 150 to the pre-charge terminal 75 and via a semiconductor switching element 146 to the pre-charge terminal 76. The pre-charge terminals 75 and 76 are coupled by a capacitor 152. The semiconductor switching element 146 is controlled by a control unit 154 to switch between a conductive state and a non-conductive state. By switching at a suitable frequency after a DC voltage is applied between the input terminals 65 and 66 (or 71 and 72), the voltage across the capacitor 152 can be increased from zero over a period of time and can reach a voltage above the voltage between the input terminals. Accordingly, the voltage between the pre-charge terminals 75 and 76, and therefore the voltage across a connected capacitor 34 to be pre-charged, increases from zero over a period of time, thereby limiting charging current.

Optionally, an input capacitor 156 can be provided and/or an interference suppression circuit 158 can be provided, for example including a suppressor diode or Zener diode and/or an EMI filter, and the semiconductor switching element 146 can be integrated with the control unit 154.

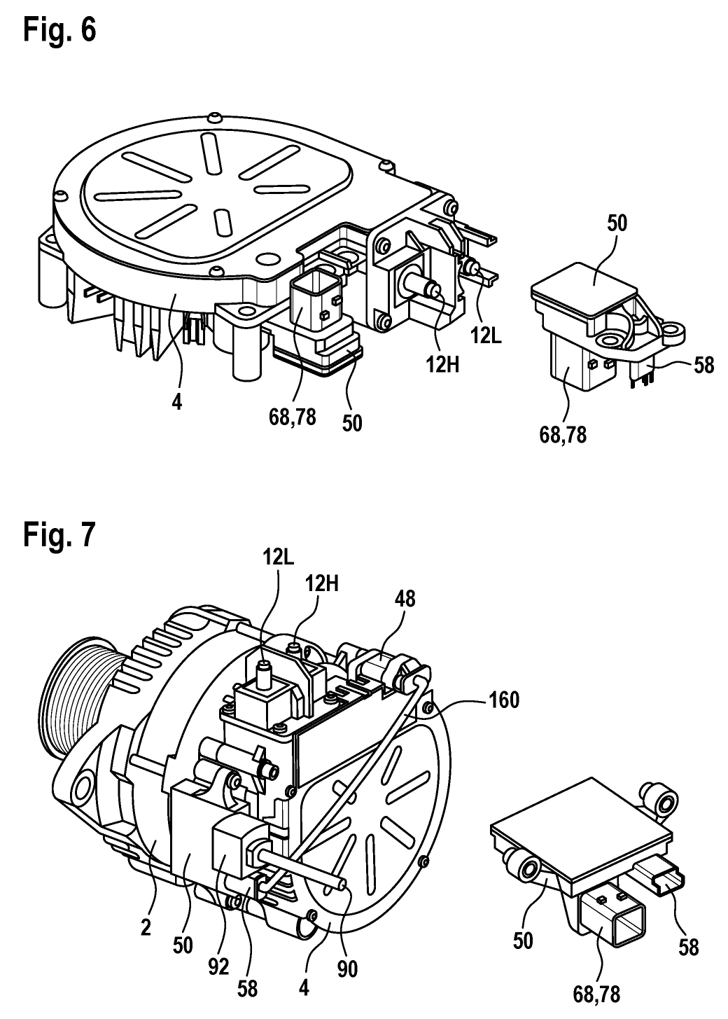

FIGS. 6, 7, and 8, illustrate perspective views of an inverter 4 and a respective connection adapter 50, each shown separately and in a mounted state at the inverter 4 and/or its housing.

In FIGS. 6, 7 and 8, the pre-charge connection section 78 is combined with the first adapter connection section 68, and this combined connection section includes a keying structure as a plug connection. The second adapter connection section 58 also includes a keying structure as a plug connection that can engage a complementary keying structure of the inverter connection section. The housing of the connection adapter 50 may have one or more protrusions or wall elements protruding from an essentially cuboid base shape, at which the connection sections of the connection adapter 50 are arranged and/or that may be considered as part of the connection sections.

The DC terminals 12H and 12L of the inverter 4 are also visible in FIGS. 6, 7, and 8.

The connection adapters 50 of FIGS. 6, 7, and 8 differ in the shape of their housings, and the shape can be selected, for example, to adapt to installation-space conditions in an engine compartment of a vehicle.

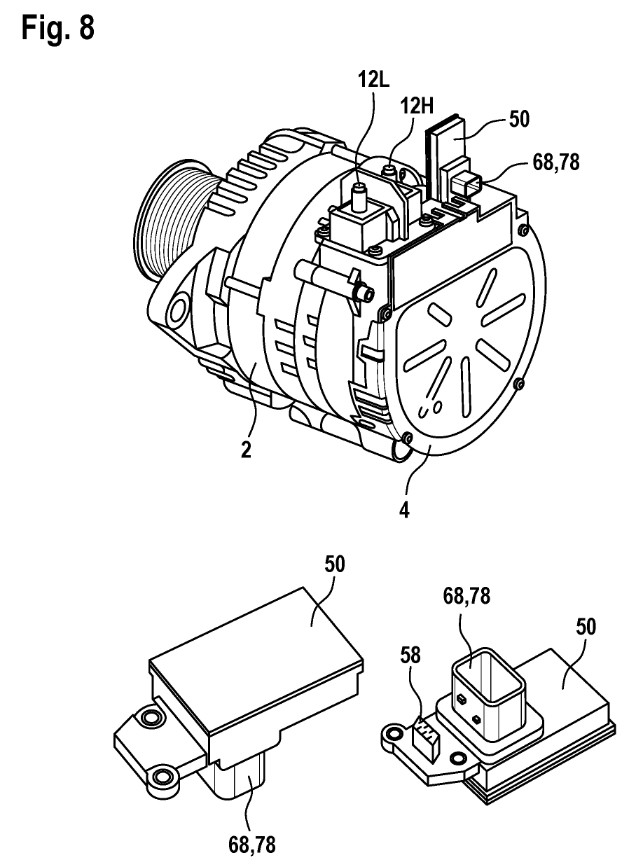

In FIG. 6, the inverter 4 is shown separately, whereas in FIGS. 7 and 8 the inverter 4 is shown connected to an electric machine 2. FIG. 7 also illustrates use of an intermediate cable 160, which can be used when there is insufficient space at the inverter connection section for the connection adapter. FIG. 7 also illustrates a cable harness 90 including a cable connection section 92 that is connected to the combined first adapter connection section 68 and pre-charge connection section 78.

1. A connection adapter for connection to an inverter of an electric machine, comprising:
at least one housing, wherein walls of the at least one housing include input terminals, output terminals, pre-charge terminals, and first and second communication and/or signal terminals;
a step-down converter arranged within the at least one housing and coupled to the input terminals and the output terminals, the step-down converter configured to convert an input voltage present at the input terminals into a lower output voltage at a predetermined output-voltage level at the output terminals; and
a pre-charge circuit arranged within the at least one housing and coupled to the input terminals and the pre-charge terminals, the pre-charge circuit configured to limit an electric current between the input terminals and the pre-charge terminals;
wherein the first and the second communication and/or signal terminals are electrically connected to one another by electrical lines running within the at least one housing; and
wherein the first communication and/or signal terminals and the input terminals are arranged in a first adapter connection section at a wall of the at least one housing, and the second communication and/or signal terminals and the output terminals are arranged in a second adapter connection section at a wall of the at least one housing.

2. The connection adapter of claim 1, wherein the at least one housing is a single housing, and wherein the pre-charge terminals are arranged in the first adapter connection section.

3. The connection adapter of claim 1, wherein the at least one housing includes a first housing and a second housing;
wherein the step-down converter is arranged within the first housing and the first and the second adapter connection sections are arranged at a wall of the first housing;
wherein the pre-charge circuit is arranged within the second housing and the pre-charge terminals are arranged in a pre-charge connection section at a wall of the second housing; and
wherein a housing connecting component is arranged between the first housing and the second housing and includes lines that connect the pre-charge circuit to the input terminals.

4. The connection adapter of claim 1, wherein the first adapter connection section includes a keying structure in the form of projections and/or recesses at the wall of the at least one housing at which the first adapter connection section is arranged.

5. The connection adapter of claim 4, wherein the keying structure of the first adapter connection section is integrally formed with the wall of the at least one housing at which the first adapter connection section is arranged.

6. The connection adapter of claim 4, wherein the keying structure of the first adapter connection section is configured as a socket or plug for a plug connection.

7. The connection adapter of claim 1, wherein the second adapter connection section includes a keying structure in the form of projections and/or recesses at the wall of the at least one housing at which the second adapter connection section is arranged.

8. The connection adapter of claim 7, wherein the keying structure of the second adapter connection section is integrally formed with the wall of the at least one housing at which the second adapter connection section is arranged.

9. The connection adapter of claim 7, wherein the keying structure of the second adapter connection section is configured as a socket or plug for a plug connection.

10. The connection adapter of claim 7, wherein the keying structure of the second adapter connection section is complementary to a keying structure of an inverter connection section on a housing of the inverter to which the connection adapter is to be connected.

11. The connection adapter of claim 1, wherein the second adapter connection section is connectable to an inverter connection section of the inverter such that the second communication and/or signal terminals and the output terminals of the second adapter connection section contact corresponding communication and/or signal terminals and voltage supply terminals in the inverter connection section when the second adapter connection section is connected to the inverter connection section.

12. The connection adapter of claim 1, wherein the input terminals include first input terminals that are coupled to the step-down converter and to the pre-charge circuit.

13. The connection adapter of claim 1, wherein the input terminals include first input terminals and second input terminals; wherein the first input terminals are coupled to the step-down converter and the second input terminals are coupled to the pre-charge circuit.

14. The connection adapter of claim 1, wherein the pre-charge circuit includes a step-up converter.

15. The connection adapter of claim 1, wherein the predetermined output-voltage level is in a range from 5 V to 18 V and is in particular 12 V.

16. The connection adapter of claim 1, wherein the step-down converter is configured such that the input voltage can be in a range from 20 V to 100 V, in particular from 20 V to 50 V.

17. The connection adapter of claim 1, wherein the second adapter connection section is arranged at a wall of the at least one housing opposite the wall of the at least one housing at which the first adapter connection section is arranged; or
wherein the first and the second adapter connection sections are arranged on the same side at a wall of the housing; or
wherein the second adapter connection section is arranged at a wall of the at least one housing that forms an angle in a range from 60° to 120° with the wall of the at least one housing at which the first adapter connection section is arranged, wherein the angle is in particular 90°.

18. A connection system for an inverter, comprising the connection adapter according to claim 1 and a cable harness having electrical lines;
wherein a cable connection section is provided at a first end of the cable harness and includes terminals coupled to the electrical lines and is connectable to, or connected to, the first adapter connection section of the connection adapter such that electrical contact is established between terminals in the cable connection section and the first communication and/or signal terminals, the input terminals, and the pre-charge terminals.

19. The connection system of claim 18, wherein the electrical lines of the cable harness include communication lines, voltage supply lines, and pre-charge lines that are routed together in the cable harness starting from the first end of the cable harness; and
wherein at a second end of the cable harness the communication lines are routed in a communication cable, the voltage supply lines are routed in a voltage supply cable, and the pre-charge lines are routed in a pre-charge cable such that the communication cable is connectable to a control unit, the voltage supply cable is connectable to a DC voltage source, and the pre-charge cable is connectable to an electrical component that includes a capacitor.

20. The connection system of claim 18, further comprising an intermediate cable having a first intermediate-cable connection section and a second intermediate-cable connection section at ends of the intermediate cable, wherein terminals in the first intermediate-cable connection section are electrically connected by electrical lines to terminals in the second intermediate-cable connection section;
wherein the first intermediate-cable connection section is connectable to the second adapter connection section such that the terminals in the first intermediate-cable connection section contact corresponding ones of the second communication and/or signal terminals and the output terminals when the first intermediate-cable connection section is connected to the second adapter connection section; and
wherein the second intermediate-cable connection section is connectable to an inverter connection section of the inverter such that the terminals in the second intermediate-cable connection section contact corresponding communication and/or signal terminals and voltage supply terminals in the inverter connection section when the second intermediate-cable connection section is connected to the inverter connection section.
